(19) United States
(12) Patent Application Publication
(10) Pub. No.: US 2016/0137888 A1
(43) Pub. Date: May 19, 2016

(54) BONDPLY ADHESIVE COMPOSITION

(71) Applicant: E I DU PONT DE NEMOURS AND COMPANY, Wilmington, DE (US)

(72) Inventor: TUNG LIN LI, NEW TAIPEI CITY (TW)

(21) Appl. No.: 14/943,473

(22) Filed: Nov. 17, 2015

Related U.S. Application Data
(60) Provisional application No. 62/081,248, filed on Nov. 18, 2014.

(51) Int. Cl. C09J 151/00

(52) U.S. Cl. CPC C09J 151/003; C08K 5/5313

(57) ABSTRACT

The present disclosure is directed to a bondply adhesive. The bondply adhesive contains 65 to 80 wt % maleic anhydride grafted styrene ethylene butadiene styrene copolymer having greater than 1 wt % maleic anhydride, 7 to 24 wt % epoxy resin, 0.3 to 3.0 wt % hardener, 0.05 to 0.1 wt % catalyst, 8 to 15 wt % organic flame retardant and 0.3 to 2.9 wt % 3-glycidyloxypropyl-trimethoxysilane, wherein a combined total of epoxy resin and organic flame retardant is less than 35 wt %.

### FIELD OF DISCLOSURE

This disclosure relates generally to adhesives. More specifically, the disclosure relates to bondply adhesive compositions.

### BACKGROUND OF THE DISCLOSURE

Adhesives for coverlay or bondply materials for high frequency applications used in flexible printed circuit board (FPCB) must have low Dₖ (dielectric constant) and low D_{f} (dissipation factor or loss tangent) to address the need for high speed signal transmission with low signal loss. The industry also desires lower lamination temperatures while maintaining good peel strength as well as good solder resistance for bondply applications.

Adhesive compositions for these applications often include epoxy and/or fluorine polymer filler particles dispersed in the resin to reduce the dielectric constant and loss in these compositions. However, the heat resistance of these adhesives is poor due the decomposition of fluorine polymer fillers at high temperature (288° C.). Resin formulations comprising poly(phenyl ether) (PPE) with vinyl functional groups, hydrogenated styrene butadiene styrene copolymer (SEBS) and epoxy/hardener to achieve low dielectric and loss tangent properties are known, however, their lamination temperatures are too high(exceeding 200° C.), which cannot meet conventional processing temperatures (180° C.).

For the forgoing reasons, a need exists for adhesive compositions having low Dₖ (dielectric constant) and low D_{f} (dissipation factor or loss tangent), good peel strength, good solder resistance and lower lamination temperatures.

### SUMMARY

The present disclosure is directed to a bondply adhesive consisting essentially thereof:

I. 65 to 80 wt % maleic anhydride grafted styrene ethylene butadiene styrene copolymer having greater that 1 wt % maleic anhydride;

II. 7 to 24 wt % epoxy resin;

III. 0.3 to 3.0 wt % hardener;

IV. 0.05 to 0.1 wt % catalyst;

V. 8 to 15 wt % organic flame retardant; and

VI. 0.3 to 2.9 wt % 3-glycidyloxypropyl-trimethoxysilane,

wherein a combined total of epoxy resin and organic flame retardant is less than 35 wt %.

### DETAILED DESCRIPTION

### Definitions

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only to those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The term “film” as used herein is intended to mean a free-standing film or a (self-supporting or non-self-supporting) coating. The term “film” is used interchangeably with the term “layer” and refers to covering a desired area.

The present disclosure is directed to an adhesive. The adhesive is well suited for high speed high frequency applications and more particularly to a bondyply adhesive for high speed high frequency applications. Adhesives for high speed high frequency applications need to have low Dₖ (dielectric constant) and low D_{f} (dissipation factor or loss tangent) and high peel strength.

It has been found that maleic anhydride functionalized SEBS provides increased peel strength over unmodified SEBS and does not increase the Dₖ or D_{f} and in some embodiments desirably lowers the Dₖ and/or D_{f}. In some embodiments, the maleic anhydride grafted styrene ethylene butadiene styrene copolymer is present from 65 to 80 wt % based on the total weight of the bondply adhesive. In some embodiments, the maleic anhydride grafted styrene ethylene butadiene styrene copolymer is present from 72 to 76 wt % based on the total weight of the bondply adhesive. In some embodiments, the maleic anhydride grafted styrene ethylene butadiene styrene copolymer is present from 72.7 to 75 wt % based on the total weight of the adhesive.

In some embodiments, the maleic anhydride grafted styrene ethylene butadiene styrene copolymer has greater than 1 wt % maleic anhydride based on the total weight of the maleic anhydride grafted styrene ethylene butadiene styrene copolymer. In some embodiments, the amount of maleic anhydride is greater than 1 wt % and less than 2 wt %. In some embodiments, maleic anhydride grafted styrene ethylene butadiene styrene copolymer has greater than 1 wt % and less than 2 wt % maleic anhydride. In some embodiments, maleic anhydride grafted styrene ethylene butadiene styrene copolymer has greater than 1 wt % and less than 1.7 wt % maleic anhydride.

The bondply adhesive composition contains 3-glycidyloxypropyl-trimethoxysilane (GLYMO). The addition of GLYMO enables the adhesive to be used in a bondply structure, as the adhesive containing GLYMO passes a solder float test at 288° C. for 10 seconds. In some embodiments, the bondply adhesive contains 0.3 to 2.9 wt % 3-glycidyloxypropyl-trimethoxysilane. In another embodiment, the bondply adhesive contains 0.3 to 2.7 wt % 3-glycidyloxypropyl-trimethoxysilane. While the addition of GLYMO enables the adhesive to be used as a bondply adhesive (solder resistant), the bondply adhesive composition of the present disclosure could also be used as an adhesive for a coverlay which does not require solder resistance. The bondply adhesive of the present disclosure has good peel strength and dielectric properties required for high speed high frequency applications.

The bondply adhesive composition contains an epoxy resin. Typically the epoxy resin enhances the crosslink density of the adhesive and further improves peel strength. In one embodiment of the present disclosure, the epoxy resin is present in an amount from 7 to 24 wt %. In another embodiment, the bondply adhesive contains 13.3 to 13.7 wt % epoxy resin. In some embodiments, the epoxy resin is a bisphenol A epoxy, bisphenol A carboxyl terminated butadiene acrylonitrile or mixtures thereof.

When an epoxy resin is present, a hardener and catalyst are used. The epoxy and the hardener react to increase crosslink density and the catalyst is used to initiate their reaction. An increase in crosslink density may increase the heat resistance of the epoxy resin and the adhesive composition in which it is contained.

In some embodiments, the bondply adhesive contains 0.3 to 3.0 wt % hardener. In another embodiment, the bondply adhesive layer contains 0.68 to 1.45 wt % hardener. In some embodiments, the hardener can be any hardener capable of reacting with an epoxy resin to increase the crosslink density. In one embodiment, the hardener is a phenolic compound. In some embodiments, the phenolic compound is selected from the group consisting of:

Novolac type phenol resin (phenol novolac),

Aralkyl type phenol resin,

Biphenyl aralkyl type phenol resin,

Multifunctional type phenol resin,

Nitrogen containing phenol resin,

Dicyclopetadiene type phenol resin,

Phosphorus containing phenol resin, and

Triazine containing phenol novolac resin.

In another embodiment, the hardener is an aromatic diamine compound. In some embodiments, the aromatic diamine compound is a diaminobiphenyl compound. In some embodiments, the diaminobiphenyl compound is 4,4′-diaminobiphenyl or 4,4′-diamino-2,2′-dimethylbiphenyl. In some embodiments, the aromatic diamine compound is a diaminodiphenylalkane compound. In some embodiments, the diaminodiphenylalkane compound is 4,4′-diaminodiphenylmethane or 4,4′-diaminodiphenylethane. In some embodiments, the aromatic diamine compound is a diaminodiphenyl ether compound. In some embodiments, the diaminodiphenyl ether compounds is 4,4′-diaminodiphenylether or di(4-amino-3-ethylphenyl)ether. In some embodiments, the aromatic diamine compound is a diaminodiphenyl thioether compound. In some embodiments, the diaminodiphenyl thioether compound is 4,4′-diaminodiphenyl thioether or di(4-amino-3-propylphenyl)thioether. In some embodiments, the aromatic diamine compound is a diaminodiphenyl sulfone compound. In some embodiments, the diaminodiphenyl sulfone compound is 4,4′-diaminodiphenyl sulfone or di(4-amino-3-isopropylphenyl)sulfone. In some embodiments, the aromatic diamine compound is phenylenediamine. In one embodiment, the hardener is an amine compound. In some embodiments, the amine compound is a guanidine. In some embodiments, the guanidine is dicyandiamide (DICY). In another embodiment, the amine compound is an aliphatic diamine. In some embodiments, the aliphatic diamine is ethylenediamine or diethylenediamine. In some embodiments, the hardener is a phenol novolac. In some embodiments, the hardener is a mixture of phenol novolacs. In some embodiments, the hardener is an active ester compound.

In some embodiments, the bondply adhesive contains 0.05 to 0.1 wt % catalyst. In another embodiment, the bondply adhesive contains 0.09 to 0.10 wt % catalyst. In some embodiments the catalyst is any catalyst capable of initiating a reaction between an epoxy resin and hardener. In some embodiments, the catalyst is selected from the group consisting of imidazole type, triazine type, 2-ethyl-4-methyl-imidazole, triazine containing phenol novolac type and mixtures thereof. In some embodiments, the catalyst is 2-ethyl-4-methyl-1h-imidazole-1-propanenitrile or 2-methyl-imidazole. In some embodiments, the catalyst is a mixture of 2-ethyl-4-methyl-1h-imidazole-1-propanenitrile or 2-methyl-imidazole. In another embodiment, the catalyst is 2-ethyl-4-methyl-1h-imidazole-1-propanenitrile, 2-methyl-imidazole or mixtures thereof.

In some embodiments, the bondply adhesive contains 8 to 15 wt % organic flame retardant. In another embodiment, the bondply adhesive contains 9.8 to 10.1 wt % organic flame retardant. In some embodiments, the organic flame retardant is an organophosphorus salt.

A bondply adhesive solution can be prepared by mixing each bondply adhesive component and solvent in any order at appropriate concentration for coating on a dielectric layer. After a homogeneous solution without precipitate is obtained, the bondply adhesive solution is coated onto a dielectric layer, typically, but not limited to, a polyimide layer. For the purpose of this disclosure, the polyimide layer used is Kapton® 50ENS (polyimide film available from DuPont-Toray Co., Ltd., Japan).

In some embodiments, suitable solvents are methyl ethyl ketone (MEK), toluene or mixture thereof. Routine experimentation may identify other suitable solvents for homogeneous solution of bondply adhesive components of the present disclosure.

Coating methods include, but are not limited to, spray coating, curtain coating, knife over roll, air knife, extrusion/slot die, gravure, reverse gravure, offset gravure, roll coating, and dip/immersion. In some embodiments board coating may be used.

After coating, the adhesive coated dielectric layer is put into a 120° C. oven for 5 minutes to evaporate the solvent. The temperature and length of time in the oven will depend on the solvent used and thickness of the adhesive. The thickness of the bondply adhesive can be controlled in accordance with the coating method used. For example, board coating can control the thickness of the bondply adhesive by adjusting the gap of the coating fixture. In some embodiments, the thickness of the bondply adhesive is from 10 to 60 microns. In another embodiment, the thickness of the bondply adhesive is from 10 to 30 microns.

The bondply adhesive coated dielectric layer may be laminated on the shiny side of rolled annealed (RA) copper foil. Any lamination method may be used. One advantage of the bondply adhesive of the present disclosure is that lower lamination temperatures may be used. The bondply adhesive of the present disclosure can be laminated to copper foil at temperatures of about 180° C. and still have good peel strength. In some embodiments, the bondply sample may be laminated to copper foil at 180° C. for 120 seconds by using quick lamination machine.

One advantage of the bondply adhesive layer of the present disclosure is solder resistance. Solder resistance is required for bondply applications where the copper foil is imaged.

One advantage of the bondply adhesive of the present disclosure is good peel strength, and in some embodiments increased peel strength. The bondply adhesive has a peel strength of at least 0.45 N/mm when laminated to copper foil at 180° C. for 120 seconds. In some embodiments, the bondply adhesive has a peel strength of 0.45 to 0.90 N/mm when laminated to copper foil at 180° C. for 120 seconds. In some embodiments, the bondply adhesive has a peel strength of 0.46 to 0.80 N/mm when laminated to copper foil at 180° C. for 120 seconds. The copper foil can be any commercial available copper foil. The copper foil is typically RA copper foil (½ oz)

Another advantage of the bondply adhesive of the present disclosure is the Dₖ and D_{f} are sufficiently low enough to enable the bondply adhesive to be used in high speed high frequency (1 to 20 GHz) applications. The bondply adhesive of the present disclosure has a dielectric constant from 2.5 to 3.0 at 10 GHz and dissipation factor from 0.0070 to 0.0090 at 10 GHz. In another embodiment, the bondply adhesive of the present disclosure has a dielectric constant from 2.69 to 2.92 at 10 GHz and a dissipation factor from 0.0072 to 0.0088 at 10 GHz.

The bondply adhesive may contain additional fillers. In some embodiments, the bondply adhesive contains dielectric filler or mixtures of dielectric fillers. Examples of useful dielectric fillers are, but are not limited to, aluminum oxide, silica, calcium carbonate, magnesium carbonate, magnesium calcium carbonate, calcium oxide, magnesium oxide, talc, magnesium silicates, aluminum silicates, magnesium aluminum silicates, calcium silicates, clay, mica, barium sulfate, boron nitride, aluminum nitride, barium titanate, strontium titanate, alumina trihydrate and calcium sulphate.

In some embodiments, the bondply adhesive of the present disclosure consisting essentially thereof:

I. 65 to 80 wt % maleic anhydride grafted styrene ethylene butadiene styrene copolymer having greater than 1 wt % maleic anhydride,

II. 7 to 24 wt % epoxy resin,

III. 0.3 to 3.0 wt % hardener,

IV. 0.05 to 0.1 wt % catalyst,

V. 8 to 15 wt % organic flame retardant, and

VI. 0.3 to 2.9 wt % 3-glycidyloxypropyl-trimethoxysilane

wherein a combined total of epoxy resin and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % maleic anhydride,

II. 7 to 24 wt % bisphenol A epoxy, bisphenol A carboxyl terminated butadiene acrylonitrile or mixtures thereof,

III. 0.3 to 3.0 wt % hardener,

IV. 0.05 to 0.1 wt % catalyst,

V. 8 to 15 wt % organic flame retardant, and

VI. 0.3 to 2.9 wt % 3-glycidyloxypropyl-trimethoxysilane

wherein a combined total of bisphenol A epoxy, bisphenol A carboxyl terminated butadiene acrylonitrile or mixtures thereof and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % maleic anhydride,

II. 7 to 24 wt % epoxy resin,

III. 0.3 to 3.0 wt % phenol novolac,

IV. 0.05 to 0.1 wt % 2-ethyl-4-methyl-1h-imidazole-1-propanenitrile or 2-methyl-imidazole,

V. 8 to 15 wt % organic flame retardant, and

VI. 0.3 to 2.9 wt % 3-glycidyloxypropyl-trimethoxysilane

wherein a combined total of epoxy resin and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % maleic anhydride,

II. 7 to 24 wt % epoxy resin,

III. 0.3 to 3.0 wt % hardener,

IV. 0.05 to 0.1 wt % catalyst,

V. 8 to 15 wt % organophosphorus salt, and

VI. 0.3 to 2.9 wt % 3-glycidyloxypropyl-trimethoxysilane

wherein a combined total of epoxy resin and organophosphorus salt is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % maleic anhydride,

II. 7 to 24 wt % bisphenol A epoxy, bisphenol A carboxyl terminated butadiene acrylonitrile or mixtures thereof,

III. 0.3 to 3.0 wt % phenol novolac,

IV. 0.05 to 0.1 wt % 2-ethyl-4-methyl-1h-imidazole-1-propanenitrile or 2-methyl-imidazole,

V. 8 to 15 wt % organophosphorus salt, and

VI. 0.3 to 2.9 wt % 3-glycidyloxypropyl-trimethoxysilane

wherein a combined total of bisphenol A epoxy, bisphenol A carboxyl terminated butadiene acrylonitrile or mixtures thereof and organophosphorus salt is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % and less than 2 wt % maleic anhydride,

II. 7 to 24 wt % epoxy resin,

III. 0.3 to 3.0 wt % hardener,

IV. 0.05 to 0.1 wt % catalyst,

V. 8 to 15 wt % organic flame retardant, and

VI. 0.3 to 2.9 wt % 3-glycidyloxypropyl-trimethoxysilane

wherein a combined total of epoxy resin and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1wt % and less than 2 wt % maleic anhydride,

II. 7 to 24 wt % bisphenol A epoxy, bisphenol A carboxyl terminated butadiene acrylonitrile or mixtures thereof,

III. 0.3 to 3.0 wt % hardener,

IV. 0.05 to 0.1 wt % catalyst,

V. 8 to 15 wt % organic flame retardant, and

VI. 0.3 to 2.9 wt % 3-glycidyloxypropyl-trimethoxysilane

wherein a combined total of bisphenol A epoxy, bisphenol A carboxyl terminated butadiene acrylonitrile or mixtures thereof and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % and less than 2 wt % maleic anhydride,

II. 7 to 24 wt % epoxy resin,

III. 0.3 to 3.0 wt % phenol novolac,

IV. 0.05 to 0.1 wt % 2-ethyl-4-methyl-1h-imidazole-1-propanenitrile or 2-methyl-imidazole,

V. 8 to 15 wt % organic flame retardant, and

VI. 0.3 to 2.9 wt % 3-glycidyloxypropyl-trimethoxysilane

wherein a combined total of epoxy resin and organic flame retardant is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % and less than 2 wt % maleic anhydride,

II. 7 to 24 wt % epoxy resin,

III. 0.3 to 3.0 wt % hardener,

IV. 0.05 to 0.1 wt % catalyst,

V. 8 to 15 wt % organophosphorus salt, and

VI. 0.3 to 2.9 wt % 3-glycidyloxypropyl-trimethoxysilane

wherein a combined total of epoxy resin and organophosphorus salt is less than 35 wt %.

In some embodiments, the bondply adhesive of the present disclosure consisting essentially thereof:

I. 65 to 80 wt % maleic anhydride grafted styrene ethylene butadiene styrene copolymer having greater than 1 wt % and less than 2 wt % maleic anhydride,

II. 7 to 24 wt % bisphenol A epoxy, bisphenol A carboxyl terminated butadiene acrylonitrile or mixtures thereof,

III. 0.3 to 3.0 wt % phenol novolac,

IV. 0.05 to 0.1 wt % 2-ethyl-4-methyl-1h-imidazole-1-propanenitrile or 2-methyl-imidazole,

V. 8 to 15 wt % organophosphorus salt, and

VI. 0.3 to 2.9 wt % 3-glycidyloxypropyl-trimethoxysilane

wherein a combined total of bisphenol A epoxy, bisphenol A carboxyl terminated butadiene acrylonitrile or mixtures thereof and organophosphorus salt is less than 35 wt %.

In some embodiments, the bondply adhesive of the present disclosure consisting essentially thereof:

I. 72.7 to 75 wt % maleic anhydride grafted styrene ethylene butadiene styrene copolymer having greater than 1 wt % maleic anhydride,

II. 13.3 to 13.7 wt % epoxy resin,

III. 0.68 to 1.45 wt % hardener,

IV. 0.09 to 0.10 wt % catalyst,

V. 8 to 15 wt % organic flame retardant, and

VI. 0.3 to 2.7 wt % 3-glycidyloxypropyl-trimethoxysilane

wherein a combined total of epoxy resin and organic flame retardant is less than 35 wt %.

In some embodiments, the bondply adhesive of the present disclosure consisting essentially thereof:

I. 72.7 to 75 wt % maleic anhydride grafted styrene ethylene butadiene styrene copolymer having greater than 1 wt % and less than 2 wt % maleic anhydride,

II. 13.3 to 13.7 wt % epoxy resin,

III. 0.68 to 1.45 wt % hardener,

IV. 0.09 to 0.10 wt % catalyst,

V. 8 to 15 wt % organic flame retardant, and

VI. 0.3 to 2.7 wt % 3-glycidyloxypropyl-trimethoxysilane

wherein a combined total of epoxy resin and organic flame retardant is less than 35 wt %.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. Numerical values are to be understood to have the precision of the number of significant figures provided. For example, the number 1 shall be understood to encompass a range from 0.5 to 1.4, whereas the number 1.0 shall be understood to encompass a range from 0.95 to 1.04, including the end points of the stated ranges. It is not intended that the scope of the invention be limited to the specific values recited when defining a range.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers, unless the context indicates or implies otherwise.

The materials, methods, and examples herein are illustrative only and, except as specifically stated, are not intended to be limiting. Although methods and materials similar or equivalent to those described herein can be used, suitable methods and materials are described herein.

### EXAMPLES

The invention will be further described in the following examples, which is not intended to limit the scope of the invention described in the claims. The materials, methods, and examples herein are illustrative only and, except as specifically stated, are not intended to be limiting. Although methods and materials similar or equivalent to those described herein can be used in the practice or testing of the present invention, suitable methods and materials are described herein.

Adhesive solution was prepared by mixing each ingredient and solvent at an appropriate concentration. After a homogeneous solution was obtained (without any precipitate), it was applied onto Kapton® 50ENS (polyimide film available from DuPont-Toray, thickness of 12.5 microns) and was put into a 120° C. oven for 5 minutes to evaporate the solvent. Bondply samples were prepared having an adhesive thickness of 20 microns for peel strength measurements and solder tests, and 50 microns for dielectric measurements.

Peel strength was measured with an AG1 Universal Testing Machine (Shimadzu Corp., Japan) following a 180 degree peel test method. Bondply samples were prepared with the bondply adhesive on a dielectric layer which was then laminated to RA copper foil (½ oz, JX-Nippon Mining & Metals Corp., Japan) with a quick lamination machine at 180° C. for 120 seconds. After that, the samples were placed into an oven at 180° C. for 1 hr. Multiple specimens were prepared with a size of 1 mm width and 8 cm length. The average of 5-10 individual measurements was recorded.

Dielectric properties (Dₖ/D_{f}) were measured using an Agilent PNA Network Analyzer with installed 85071E software and a resonance cavity frequency of 10 GHz. Samples were prepared with the dielectric layer only by heating in an oven at 180° C. for 1 hr before testing. The individual sample size was 8 cm by 10 cm. The average of 2-3 individual measurements was recorded.

For solder tests, a bondply adhesive sample was prepared with the bondply adhesive on a dielectric layer which was then laminated to RA copper foil (½ oz) with a quick lamination machine at 180° C. for 120 seconds. After that, the sample was placed into an oven at 180° C. for 1 hr. Individual samples were 5 cm by 5 cm. Samples were floated on the solder surface at 288° C. for 10 seconds and visually inspected for defects (e.g., blistering, delamination, etc.). The average of 3 individual measurements was recorded. Visual inspection was recorded as “pass” only if all three samples were defect-free. If any of the three samples had defects, it was recorded as “fail”.

Examples 1-18 and Comparative Examples 1-7 demonstrate that adhesives having maleic anhydride grafted SEBS (MA-g-SEBS)/epoxy systems, with GLYMO, different grafted MA amounts, different epoxies and amounts, different hardeners and amounts, and different flame retardant amounts can achieve desirable dielectric properties for bondply adhesive applications, with good solder resistance as well as good peel strength.

### Example 1

An adhesive solution was prepared, consisting of 73.3 wt % MA-g-SEBS (Taipol SEBS 7131, containing 1.38 wt % maleic anhydride, available from Taiwan Synthetic Rubber Corp. (TSRC), Taiwan), 13.4 wt % epoxy resin (HyPox™ RK84L bisphenol A carboxyl terminated butadiene acrylonitrile, available from CVC Thermoset Specialties, Moorestown, N.J.), 0.68 wt % hardener (BRG-557 available from Showa Denko K.K., Japan), 0.095 wt % catalyst (2E4MI-CN available from Sigma-Aldrich Co., St. Louis, Mo.), 9.9 wt % organophosphorus salt (Exolit® OP 935 available from Clariant SE, Switzerland), 2.7 wt % coupling agent (GLYMO available from Evonik Industries, Germany) and toluene as solvent. The solution was mixed by mechanical stirring until it became a homogeneous solution (no precipitate) then coated on Kapton® 50ENS polyimide film using a board coater (Coatmaster 509MC, Erichsen GmbH & Co. KG, Germany). After that, the coated film was placed into an oven at 120° C. for 5 mins to eliminate the solvent.

For peel strength and solder inspection, bondply samples were prepared as described above.

For Dₖ and D_{f} measurements, adhesive thickness was controlled at 50 microns on Kapton® 50ENS. Sample preparation and measurement are described above.

Results are shown in Table 1

### Comparative Example 1

An adhesive solution was prepared, consisting of 75.3 wt % MA-g-SEBS (Taipol SEBS 7131), 13.7 wt % epoxy (HyPox™ RK84L), 0.7 wt % hardener (BRG-557), 0.098 wt % catalyst (2E4MI-CN), 10.2 wt % organophosphorus salt (Exolit® OP 935) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 2

An adhesive solution was prepared, consisting of 73.3 wt % MA-g-SEBS (Taipol SEBS 7131), 13.4 wt % epoxy (HyPox™ RK84L), 0.68 wt % hardener (BRG-557), 0.10 wt % catalyst (2E4MI-CN), 9.9 wt % organophosphorus salt (Exolit® OP 935), 2.7 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 3

An adhesive solution was prepared, consisting of 72.7 wt % MA-g-SEBS (Taipol SEBS 7131), 13.3 wt % epoxy (jER™ 1001 available from Mitsubishi Chemical Corp., Japan), 1.45 wt % hardener (BRG-557), 0.09 wt % catalyst (2E4MI-CN), 9.8 wt % organophosphorus salt (Exolit® OP 935), 2.7 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 4

An adhesive solution was prepared, consisting of 73.3 wt % MA-g-SEBS (Taipol SEBS 7131), 13.4 wt % epoxy (HyPox™ RK84L), 0.68 wt % hardener (PF8090 available from CCP Group, Taiwan), 0.10 wt % catalyst (2E4MI-CN), 9.9 wt % organophosphorus salt (Exolit® OP 935), 2.7 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 5

An adhesive solution was prepared, consisting of 73.3 wt % MA-g-SEBS (Taipol SEBS 7131), 13.4 wt % epoxy (HyPox™ RK84L), 0.68 wt % hardener (BRG-557), 0.10 wt % catalyst (2MI available from Aldrich), 9.9 wt % organophosphorus salt (Exolit® OP 935), 2.7 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 6

An adhesive solution was prepared, consisting of 74.5 wt % MA-g-SEBS (Taipol SEBS 7131), 13.6 wt % epoxy (HyPox™ RK84L), 0.69 wt % hardener (BRG-557), 0.10 wt % catalyst (2E4MI-CN), 10.1 wt % organophosphorus salt (Exolit® OP 935), 1.0 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 7

An adhesive solution was prepared, consisting of 75.0 wt % MA-g-SEBS (Taipol SEBS 7131), 13.7 wt % epoxy (HyPox™ RK84L), 0.70 wt % hardener (BRG-557), 0.10 wt % catalyst (2E4MI-CN), 10.1 wt % organophosphorus salt (Exolit® OP 935), 0.3 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Comparative Example 2

An adhesive solution was prepared, consisting of 68.1 wt % MA-g-SEBS (Taipol SEBS 7131), 12.4 wt % epoxy (HyPox™ RK84L), 0.63 wt % hardener (BRG-557), 0.09 wt % catalyst (2E4MI-CN), 16.2 wt % flame retardant (phosphazene, SPB100 available from Otsuka Chemical Co. Ltd., Japan), 2.7 wt % coupling agent (GLYMO) and toluene as the solvent. After mixing by mechanical stirring, a homogeneous solution could not be obtained.

Results are shown in Table 1.

### Comparative Example 3

An adhesive solution was prepared, consisting of 43.4 wt % MA-g-SEBS (Taipol SEBS 7131), 41.7 wt % epoxy (HyPox™ RK84L), 2.12 wt % hardener (BRG-557), 0.3 wt % catalyst (2E4MI-CN), 9.8 wt % organophosphorus salt (Exolit® OP 935), 2.7 wt % coupling agent (GLYMO) and toluene as the solvent. After mixing by mechanical stirring, a homogeneous solution could not be obtained.

Results are shown in Table 1.

### Comparative Example 4

An adhesive solution was prepared, consisting of 50.5 wt % MA-g-SEBS (Taipol SEBS 7131), 33.7 wt % epoxy (HyPox™ RK84L), 1.72 wt % hardener (BRG-557), 0.24 wt % catalyst (2E4MI-CN), 9.6 wt % organophosphorus salt (Exolit® OP 935), 4.2 wt % coupling agent (GLYMO) and toluene as the solvent. After mixing by mechanical stirring, a homogeneous solution could not be obtained.

Results are shown in Table 1.

### Comparative Example 5

An adhesive solution was prepared, consisting of 82.5 wt % epoxy (HyPox™ RK84L), 4.21 wt % hardener (BRG-557), 0.59 wt % catalyst (2E4MI-CN), 10.0 wt % organophosphorus salt (Exolit® OP 935, 2.7 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Comparative Example 6

An adhesive solution was prepared, consisting of 73.0 wt % MA-g-SEBS (Taipol SEBS 7131), 13.4 wt % epoxy (HyPox™ RK84L), 0.68 wt % hardener (BRG-557), 0.10 wt % catalyst (2E4MZ-CN available from Aldrich), 9.9 wt % organophosphorus salt (Exolit® OP 935), 3.0 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 1.

### Example 8

An adhesive solution was prepared, consisting of 75 wt % MA-g-SEBS (Taipol SEBS 7131) with MA grafting of 1.3 wt %, 13.7 wt % epoxy (HyPox™ RK84L), 0.07 wt % hardener (BRG-557), 0.01 wt % catalyst (2E4MI-CN), 10.1 wt % organophosphorus salt (Exolit® OP 935), 0.38 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 9

An adhesive solution was prepared as in Example 8 with MA-g-SEBS (Taipol SEBS 7131), but with MA grafting of 1.38 wt %. The solution was mixed, coated on polyimide film and dried following the procedure of Example 1.

For peel strength, solder inspection and dielectric measurement, the test methods are the same as Example 1.

Results are shown in Table 2.

### Example 10

An adhesive solution was prepared as in Example 8 with MA-g-SEBS (Taipol SEBS 7131), but with MA grafting of 1.6 wt %. The solution was mixed, coated on polyimide film and dried following the procedure of Example 1.

For peel strength, solder inspection and dielectric measurement, the test methods are the same as Example 1.

Results are shown in Table 2.

### Comparative Example 7

An adhesive solution was prepared as in Example 8 with MA-g-SEBS (Taipol SEBS 7131), but with MA grafting of 1.0 wt %. After mixing by mechanical stirring, a homogeneous solution could not be obtained.

Results are shown in Table 2.

### Example 11

An adhesive solution was prepared, consisting of 80.9 wt % MA-g-SEBS (Kraton® FG1901-GT available from Kraton Performance Polymers, Inc., Houston, Tex.) with MA grafting of 1.8 wt %, 7.38 wt % epoxy (HyPox™ RK84L), 0.38 wt % hardener (BRG-557), 0.05 wt % catalyst (2E4MI-CN), 10.9 wt % organophosphorus salt (Exolit® OP 935), 0.41 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 12

An adhesive solution was prepared, consisting of 75 wt % MA-g-SEBS (Kraton® FG1901-GT) with MA grafting of 1.8 wt %, 13.7 wt % epoxy (HyPox™ RK84L), 0.7 wt % hardener (BRG-557), 0.10 wt % catalyst (2E4MI-CN), 10.1 wt % organophosphorus salt (Exolit® OP 935), 0.38 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 13

An adhesive solution was prepared, consisting of 65.6 wt % MA-g-SEBS (Kraton® FG1901-GT) with MA grafting of 1.8 wt %, 23.9 wt % epoxy (HyPox™ RK84L), 1.23 wt % hardener (BRG-557), 0.09 wt % catalyst (2E4MI-CN), 8.83 wt % organophosphorus salt (Exolit® OP 935), 0.33 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 14

An adhesive solution was prepared, consisting of 75 wt % MA-g-SEBS (Kraton® FG1901-GT) with MA grafting of 1.8 wt %, 13.7 wt % epoxy (HyPox™ RK84L), 0.93 wt % hardener (BRG-557), 0.10 wt % catalyst (2E4MI-CN), 10.1 wt % organophosphorus salt (Exolit® OP 935), 0.38 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 15

An adhesive solution was prepared, consisting of 75 wt % MA-g-SEBS (Kraton® FG1901-GT) with MA grafting of 1.8 wt %, 13.6 wt % epoxy (HyPox™ RK84L), 1.25 wt % hardener (BRG-557), 0.10 wt % catalyst (2E4MI-CN), 10.04 wt % organophosphorus salt (Exolit® OP 935), 0.37 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 16

An adhesive solution was prepared, consisting of 78.9 wt % MA-g-SEBS (Kraton® FG1901-GT) with MA grafting of 1.8 wt %, 7.20 wt % multifunctional epoxy (Epalloy® 8280 epoxidized phenol novolac resin available from CVC), 2.89 wt % hardener (BRG-557), 0.05 wt % catalyst (2E4MI-CN), 10.61 wt % organophosphorus salt (Exolit® OP 935), 0.40 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

### Example 17

An adhesive solution was prepared, consisting of 71.4 wt % MA-g-SEBS (Kraton® FG1901-GT) with MA grafting of 1.8 wt %, 13.03 wt % epoxy (HyPox™ RK84L), 0.67 wt % hardener (BRG-557), 0.10 wt % catalyst (2E4MI-CN), 14.4 wt % organophosphorus salt (Exolit® OP 935), 0.36 wt % coupling agent (GLYMO) and toluene as solvent. The solution was mixed, coated on polyimide film and dried following the procedure of Example 1.

For peel strength, solder inspection and dielectric measurement, the test methods are the same as Example 1.

Results are shown in Table 2.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. All features disclosed in this specification may be replaced by alternative features serving the same, equivalent or similar purpose. Accordingly, the specification is to be regarded in an illustrative rather than a restrictive sense and all such modifications are intended to be included within the scope of the invention.

TABLE 1

| | wt % | wt | wt | wt | wt % | wt | Peel | Dₖ | D_{f} | Solder |
|---|---|---|---|---|---|---|---|---|---|---|
| | MA-g- | % | % | % | flame | % | Strength | (@ 10 | (@ 10 | 288° C. |
| | SEBS | epoxy | hardener | catalyst | retardant | GLYMO | (N/mm) | GHz) | GHz) | 10 s |
| Example 1 | 73.3 | 13.4 | 0.68 | 0.095 | 9.9 | 2.7 | 0.73 | 2.73 | 0.0075 | pass |
| Comp. Ex 1 | 75.3 | 13.7 | 0.7 | 0.098 | 10.2 | — | 0.68 | 2.7 | 0.0071 | fail |
| Example 2 | 73.3 | 13.4 | 0.68 | 0.10 | 9.9 | 2.7 | 0.73 | 2.78 | 0.0082 | pass |
| Example 3 | 72.7 | 13.3 | 1.45 | 0.09 | 9.8 | 2.7 | 0.52 | 2.92 | 0.0088 | pass |
| Example 4 | 73.3 | 13.4 | 0.68 | 0.10 | 9.9 | 2.7 | 0.62 | 2.82 | 0.0074 | pass |
| Example 5 | 73.3 | 13.4 | 0.68 | 0.10 | 9.9 | 2.7 | 0.8 | 2.82 | 0.0072 | pass |
| Example 6 | 74.5 | 13.6 | 0.69 | 0.10 | 10.1 | 1 | 0.46 | 2.69 | 0.0076 | pass |
| Example 7 | 75 | 13.7 | 0.70 | 0.10 | 10.1 | 0.3 | 0.55 | 2.79 | 0.0077 | pass |
| Comp. Ex 2 | 68.1 | 12.4 | 0.63 | 0.09 | 16.2 | 2.5 | — | — | — | — |
| Comp. Ex 3 | 43.4 | 41.7 | 2.12 | 0.3 | 9.8 | 2.7 | — | — | — | — |
| Comp. Ex 4 | 50.5 | 33.7 | 1.72 | 0.24 | 9.6 | 4.2 | — | — | — | — |
| Comp. Ex 5 | — | 82.5 | 4.21 | 0.59 | 10 | 2.7 | 1.17 | 2.95 | 0.022 | pass |
| Comp. Ex 6 | 73 | 13.4 | 0.68 | 0.10 | 9.9 | 3 | 0.29 | 2.78 | 0.0088 | pass |

TABLE 2

| | wt % | | | | | wt | | | | | |
|---|---|---|---|---|---|---|---|---|---|---|---|
| | MA | wt % | wt | wt | wt | % | wt | Peel | Dₖ | D_{f} | Solder |
| | grafted | MA-g- | % | % | % | flame | % | Strength | (@ 10 | (@ 10 | 288° C. |
| | on SEBS | SEBS | epoxy | hardener | catalyst | retardant | GLYMO | (N/mm) | GHz) | GHz) | 10 s |
| Example 8 | 1.3 | 75 | 13.7 | 0.07 | 0.01 | 10.1 | 0.38 | 0.86 | 2.75 | 0.0057 | pass |
| Example 9 | 1.38 | 75 | 13.7 | 0.07 | 0.01 | 10.1 | 0.38 | 0.38 | 2.82 | 0.0059 | pass |
| Example 10 | 1.6 | 75 | 13.7 | 0.07 | 0.01 | 10.1 | 0.38 | 0.53 | 2.85 | 0.0068 | pass |
| Comp. Ex 7 | 1 | 75 | 13.7 | 0.07 | 0.01 | 10.1 | 0.38 | — | — | — | — |
| Example 11 | 1.8 | 80.9 | 7.38 | 0.38 | 0.05 | 10.9 | 0.41 | 1.03 | 2.55 | 0.0037 | pass |
| Example 12 | 1.8 | 75 | 13.7 | 0.7 | 0.10 | 10.1 | 0.38 | 1.00 | 2.57 | 0.0034 | pass |
| Example 13 | 1.8 | 65.6 | 23.9 | 1.23 | 0.09 | 8.83 | 0.33 | 0.68 | 2.71 | 0.0055 | pass |
| Example 14 | 1.8 | 75 | 13.7 | 0.93 | 0.10 | 10.1 | 0.38 | 0.79 | 2.52 | 0.0036 | pass |
| Example 15 | 1.8 | 75 | 13.6 | 1.25 | 0.10 | 10.04 | 0.37 | 0.78 | 2.61 | 0.0036 | pass |
| Example 16 | 1.8 | 78.9 | 7.20 | 2.89 | 0.05 | 10.61 | 0.40 | 0.93 | 2.51 | 0.0036 | pass |
| Example 17 | 1.8 | 71.4 | 13.03 | 0.67 | 0.10 | 14.4 | 0.36 | 1.18 | 2.65 | 0.0054 | pass |

What is claimed is:

1. A bondply adhesive consisting essentially thereof:
I. 65 to 80 wt % maleic anhydride grafted styrene ethylene butadiene styrene copolymer having greater that 1 wt % maleic anhydride;
II. 7 to 24 wt % epoxy resin;
III. 0.3 to 3.0 wt % hardener;
IV. 0.05 to 0.1 wt % catalyst;
V. 8 to 15 wt % organic flame retardant; and
VI. 0.3 to 2.9 wt % 3-glycidyloxypropyl-trimethoxysilane
wherein a combined total of epoxy resin and organic flame retardant is less than 35 wt %.

2. The bondply adhesive in accordance with claim 1 wherein said maleic anhydride grafted styrene ethylene butadiene styrene copolymer has greater than 1 wt % and less than 2 wt % maleic anhydride.

3. The bondply adhesive in accordance with claim 1 wherein the epoxy resin is a bisphenol A epoxy, bisphenol A carboxyl terminated butadiene acrylonitrile or mixtures thereof.

4. The bondply adhesive in accordance with claim 1 wherein the hardener is a phenol novolac and the catalyst is 2-ethyl-4-methyl-1h-imidazole-1-propanenitrile or 2-methyl-imidazole.

5. The bondply adhesive in accordance with claim 1 wherein the organic flame retardant is an organophosphorus salt.

6. The bondply adhesive in accordance with claim 1 having a peel strength of at least 0.45 N/mm when laminated to copper foil at 180° C. for 120 seconds.

7. The bondply adhesive in accordance with claim 1 having a peel strength of 0.45 to 0.90 N/mm when laminated to copper foil at 180° C. for 120 seconds.

8. The bondply adhesive in accordance with claim 1 having a dielectric constant from 2.5 to 3.0 at 10 GHz and a dissipation factor from 0.0070 to 0.0090 at 10 GHz.
